(19) United States
(12) Patent Application Publication
(10) Pub. No.: US 2022/0154555 A1
(43) Pub. Date: May 19, 2022

(54) SYSTEM FOR HYDRAULIC FRACTURING INTEGRATED WITH ELECTRICAL ENERGY STORAGE AND BLACK START CAPABILITY

(71) Applicant: Siemens Energy, Inc., Orlando, FL (US)

(72) Inventors: Dalia El Tawy, Houston, TX (US); Arvind Sriraman, Houston, TX (US); Lynn Wheatcraft, Richmond, TX (US)

(21) Appl. No.: 17/439,730

(22) PCT Filed: Jul. 16, 2019
(86) PCT No.: PCT/US2019/041935

§ 371 Date: Sep. 15, 2021

Related U.S. Application Data
(60) Provisional application No. 62/839,104, filed on Apr. 26, 2019.

(51) Int. Cl. E21B 41/00; E21B 43/26

(52) U.S. Cl. CPC E21B 41/0085; E21B 43/2607

(57) ABSTRACT

System 10 for hydraulic fracturing is provided. The system may involve a mobile hybrid power-generating subsystem (25) including a gas turbine engine 14 and an electrical energy storage system 16. Power-generating subsystem (25) further including an electromotive machine 12 that may be configured to operate in a motoring mode or in a generating mode. During motoring, electromotive machine 12 may be responsive to electrical power from energy storage system 16 to provide black start of gas turbine 14. Gas turbine engine 14, electrical energy storage system 16 and electromotive machine 12 may be arranged on a power generation mobile platform (22) so that a subsystem so arranged can be transportable from one physical location to another, and effectively constitutes a self-contained, mobile hybrid power-generating subsystem that may operate fully independent from utility power or external power sources.

### CROSS-REFERENCE TO RELATED APPLICATIONS

This application claims benefit of the Apr. 26, 2019 filing date of U.S. provisional application 62/839,104, which is incorporated by reference herein.

### BACKGROUND

### 1. Field

Disclosed embodiments relate generally to the field of hydraulic fracturing, such as used in connection with oil and gas applications, and, more particularly, to a system for hydraulic fracturing, and, even more particularly, to system integrating a gas turbine engine with electrical energy storage and having black start capability for the gas turbine engine.

### 2. Description of the Related Art

Hydraulic fracturing is a process used to foster production from oil and gas wells. Hydraulic fracturing generally involves pumping a high-pressure fluid mixture that may include particles/proppants and optional chemicals at high pressure through the wellbore into a geological formation. As the high-pressure fluid mixture enters the formation, this fluid fractures the formation and creates fissures. When the fluid pressure is released from the wellbore and formation, the fractures or fissures settle, but are at least partially held open by the particles/proppants carried in the fluid mixture. Holding the fractures open allows for the extraction of oil and gas from the formation.

Certain known hydraulic fracturing systems may use large diesel engine-powered pumps to pressurize the fluid mixture being injected into the wellbore and formation. These large diesel engine-powered pumps may be difficult to transport from site to site due to their size and weight, and are equally—if not more—difficult to move or position in a remote and undeveloped wellsite, where paved roads and space to maneuver may not be readily available. Further, these large diesel engine powered pumps require large fuel storage tanks, which must also be transported to the wellsite. Another drawback of systems involving diesel engine-powered pumps is the burdensome maintenance requirements of diesel engines, which generally involve significant maintenance operations approximately every 300-400 hours, thus resulting in regular downtime of the engines approximately every 2-3 weeks. Moreover, the power-to-weight ratio of prior art mobile systems involving diesel engine-powered pumps tends to be relatively low.

To try to alleviate some of the difficulties involved with diesel engine-powered fracturing pump systems, certain electrically-driven hydraulic fracturing systems have been proposed. For an example of one approach involving an electric hydraulic system, see International Publication WO 2018/071738 A1.

### BRIEF DESCRIPTION

A disclosed embodiment is directed to a system for hydraulic fracturing. The system may include a gas turbine engine, an electrical energy storage system, and an electromotive machine mechanically coupled to the gas turbine engine. The electromotive machine may be configured to operate in a motoring mode or in a generating mode. The electromotive machine in the motoring mode may be responsive to electrical power from the electrical energy storage system to provide a black start of the gas turbine engine. The gas turbine, the electrical energy storage system and the electromotive machine may be arranged on a respective power generation mobile platform.

A further disclosed embodiment is directed to a system for hydraulic fracturing. The system may include a gas turbine engine, an electrical energy storage system, and an electromotive machine mechanically coupled to the gas turbine engine. The electromotive machine may be configured to operate in a motoring mode or in a generating mode. The electromotive machine in the motoring mode may be responsive to electrical power from the electrical energy storage system to provide a black start of the gas turbine engine. The system may further include a bi-directional power converter electrically interconnected between the energy storage system and the electromotive machine to selectively provide bi-directional power conversion between the electrical energy storage system and the electromotive machine. An energy management system may be configured to execute a power control strategy for blending power from the energy storage system and power generated by the electromotive machine during the generating mode to meet variable power demands of a hydraulic fracturing subsystem. The gas turbine engine, the electrical energy storage system, the electromotive machine, the bi-directional power converter, and the energy management system may be arranged on a respective power generation mobile platform.

### BRIEF DESCRIPTION OF THE DRAWINGS

FIG. 1 illustrates a block diagram of one non-limiting embodiment of a disclosed system that may involve a mobile, hybrid power-generating subsystem integrated with electrical energy storage that may be configured to provide black start capability.

FIG. 2 illustrates a block diagram of one non-limiting example of a circuit topology that may be used in a hybrid electrical energy storage subsystem that may be optionally used in a disclosed system.

FIG. 3 illustrates a block diagram of a scalable, mobile, micro-grid hybrid power-generating system that may be formed using, as basic building blocks, two or more disclosed mobile, hybrid power-generating subsystems as shown in FIG. 1.

### DETAILED DESCRIPTION

The present inventors have recognized that typical prior art systems for hydraulic fracturing may be heavily dependent on the operational availability of prime movers typically based on fossil fuel engine technology, such as diesel engines, and gas turbine engines. To address reliability concerns, well operators may use configurations involving multiple levels of redundancies; for example, N+1 or N+2 redundant engine configurations. Typically, the redundant engines, along with transmissions and pumps mounted on pump trailers, may be hydraulically connected to a given well, but often, at any given time, at least some of the engines may be sub-optimally operated, for example, in an idle mode. Concomitant drawbacks of this redundant approach may include requiring more space at the site, burning increased amounts of fuel, requiring more tractors and drivers, more labor and/or time involved to rig-up and rig-down, all of which significantly adding to operating costs.

At least in view of such recognition, disclosed embodiments formulate an innovative approach for integrating electrical energy storage in a system for hydraulic fracturing. Disclosed embodiments are believed to cost-effectively and reliably provide the necessary power-generation functionality that may be needed to electrically power hydraulic pumps utilized in a fracturing process. This may be achieved by way of optimized utilization of electrical energy derived from a gas turbine engine and electrical energy supplied by an electrical energy storage system.

Disclosed embodiments also offer a compact and self-contained, mobile, hybrid power-generating subsystem having black-start capability for the gas turbine engine. Disclosed embodiments may be configured with smart algorithms to prioritize and determine charging/discharging modes and power source allocation for optimization conducive to maximize the reliability and durability of the power sources involved while meeting the variable power demands of loads that may be involved in the hydraulic fracturing process.

In the following detailed description, various specific details are set forth in order to provide a thorough understanding of such embodiments. However, those skilled in the art will understand that disclosed embodiments may be practiced without these specific details that the aspects of the present invention are not limited to the disclosed embodiments, and that aspects of the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

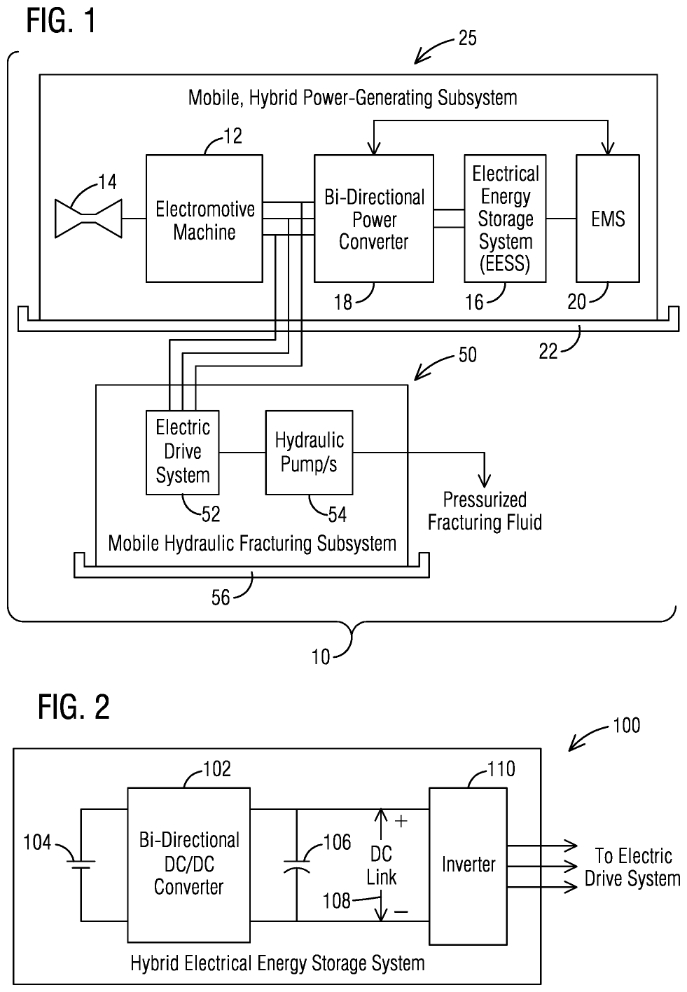

FIG. 1 illustrates a block diagram of one non-limiting embodiment of a system 10 for hydraulic fracturing that may involve a mobile, hybrid power-generating subsystem 25, and may further involve a hydraulic fracturing subsystem 50, mobile or otherwise. As shown in FIG. 1, mobile, hybrid power-generating subsystem 25 may include an electromotive machine 12 mechanically coupled to a gas turbine engine 14. In one non-limiting embodiment, gas turbine engine 14 may be an aeroderivative gas turbine engine, such as model SGT-A05 aeroderivative gas turbine engine available from Siemens. There are several advantages of aero-derivative gas turbines that may be particularly beneficial in a mobile fracturing application. Without limitation, an aero-derivative gas turbine is relatively lighter in weight and relatively more compact than an equivalent industrial gas turbine, which are favorable attributes in a mobile fracturing application. Depending on the needs of a given application, another non-limiting example of gas turbine engine 24 may be model SGT-300 industrial gas turbine engine available from Siemens. It will be appreciated that disclosed embodiments are not limited to any specific model or type of gas turbine engine.

In one non-limiting embodiment, electromotive machine 12 may be selectively configured to operate in a motoring mode or in a generating mode. Electromotive machine 12, when operable in the motoring mode, may be responsive to electrical power from an electrical energy storage system 16 that, without limitation, may be used to provide a black start to gas turbine engine 14. In one non-limiting embodiment, electrical energy storage system 16 may be a battery energy storage system, such as based on lithium-ion battery technology, or other battery technologies, such as flow-based battery technology, or a combination of different battery technologies, etc. For readers desirous of further background information regarding use of batteries for energy storage, reference is made to paper titled “Lead Batteries for Utility Energy Storage: A Review”, by G. J. May, A. Davidson, and B. Monahov, Journal of Energy Storage, Volume 15, February 2018, Pages 145-157, published by Elsevier Ltd.

In one non-limiting embodiment, a bi-directional power converter 18 may be electrically interconnected between energy storage system 16 and electromotive machine 12 to selectively provide bi-directional power conversion between electrical energy storage system 16 and electromotive machine 12. For example, in case electromotive machine 12 is an AC type of electromotive machine, the power conversion may involve conversion from direct current (DC) to alternating current (AC) when extracting power from electrical energy storage system 16 to appropriately energize AC electromotive machine 12 for motoring action. Conversely, the power conversion may involve conversion from AC to DC when converting power generated by AC electromotive machine 12 to, for example, charge electrical energy storage system 16.

In case electromotive machine 12 is a DC type of electromotive machine, for example, when extracting power from electrical energy storage system 16 to, for example, energize DC electromotive machine 12 for motoring action, bi-directional power converter 18 may be arranged to convert a DC voltage level supplied by electrical energy storage system 16 to a DC voltage level suitable for driving electromotive machine 12. Conversely, during power-generating action by DC electromotive machine 12, bi-directional power converter 18 may convert the DC voltage generated by DC electromotive machine 12 to a DC voltage level suitable for storing energy in electrical energy storage system 16.

In one non-limiting embodiment, an energy management subsystem (EMS) 20 may be configured to execute a power control strategy for blending power from electrical energy storage system 16 and electromotive machine 12.

In one non-limiting embodiment, the components of mobile, hybrid power-generating system 25, such as gas turbine engine 14, electromotive machine 12, electrical energy storage system 16, bi-directional power converter 18, and EMS 20 may each mounted onto a respective power generation mobile platform 22 (e.g., a singular mobile platform) that can propel itself (e.g., a self-propelled mobile platform); or can be towed or otherwise transported by a self-propelled vehicle and effectively form a self-contained, mobile hybrid power-generating subsystem. It will be appreciated that this self-contained, mobile hybrid power-generating subsystem may operate fully independent from utility power or any external power sources.

That is, each of the foregoing components of mobile, hybrid power-generating subsystem 25 may be respectively mounted onto power generation mobile platform 22 so that mobile, hybrid power-generating subsystem 25 is transportable from one physical location to another. For example, power generation mobile platform 22 may represent a self-propelled vehicle alone, or in combination with a non-motorized cargo carrier (e.g., semi-trailer, full-trailer, dolly, skid, barge, etc.) with the subsystem components disposed onboard the self-propelled vehicle and/or the non-motorized cargo carrier. As suggested above, power generation mobile platform 22 need not be limited to land-based transportation and may include other transportation modalities, such as rail transportation, marine transportation, etc.

In one non-limiting embodiment, hydraulic fracturing subsystem 50, may include one or more hydraulic pumps 54 powered by an electric drive system 52 (e.g., an electric motor alone or in combination with a drive), at least in part responsive to electrical power generated by electromotive machine 12 during the generating mode. Hydraulic pump/s 54 may be arranged to deliver a pressurized fracturing fluid, such as may be conveyed to a well head to be conveyed through the wellbore of a well into a given geological formation.

In the event hydraulic fracturing subsystem 50 is a mobile hydraulic fracturing subsystem, electric drive 52 and hydraulic pump's 54 may be mounted on a respective mobile platform 56 (e.g., a singular mobile platform). Structural and/or operational features of mobile platform 56 may be as described above in the context of power generation mobile platform 22. Accordingly, mobile hydraulic fracturing subsystem 50 may be transportable from one physical location to another.

In one non-limiting embodiment, the power control strategy by EMS 20 is configured so that power from electrical energy storage system 16 and power generated by electromotive machine 12 can appropriately meet variable power demands of hydraulic fracturing subsystem 50.

In one non-limiting embodiment, EMS 20 may be configured to autonomously select electrical energy storage system 16 as a supplemental power source to meet peak loads in mobile hydraulic fracturing subsystem 50. This may be accomplished without having to subject gas turbine engine 14 to thermomechanical stresses that otherwise gas turbine engine 14 would be subject to in order to meet such peak loads, if, for example, electrical energy storage system 16 was not available as a supplemental power source. Similarly, electrical energy storage system 16 may be used as a supplemental power source to compensate for decreased power production of gas turbine engine 14 under challenging environmental conditions, such as high-altitude operation, humid and hot environmental conditions, etc.

In one non-limiting embodiment, EMS 20 may be configured to control a state-of-charge (SoC) of the battery energy storage system. For example, based on the charging input and output requirements of a given application, the battery energy storage system may not be returned to a fully charged condition and may be operated in a partial SoC (PSoC) condition chosen to maximize battery longevity, where the level of PSoC may be tailored based on battery chemistry, environmental conditions, etc.

In one non-limiting embodiment, as illustrated in FIG. 2, the electrical energy storage system may optionally comprise a hybrid, electrical energy storage system (HESS) 100, such as may involve different types of electrochemical devices, such as without limitation, an ultracapacitor (UC)-based energy storage module 106 and a battery-based energy storage module 104. The basic idea is to synergistically combine these devices to achieve a better overall performance. For example, batteries have a relatively high energy density, which varies with chemistry and power density of the specific battery technology involved. Compared to batteries, UCs have a relative lower energy density but substantially higher power density. Additionally, the life of UCs may typically be over approximately one million cycles, which is relatively higher than that of batteries. Also, UCs may have superior low-temperature performance compared to batteries. These various characteristics allow for an optimal combination that may be tailored to achieve an improved overall performance in a given hydraulic fracturing application.

FIG. 2 illustrates one non-limiting example of one illustrative circuit topology that may be used in HESS 100. In this example topology, by way of a bi-directional DC/DC converter 102, the voltage of battery-based energy storage module 104 can be maintained lower or higher than the voltage of ultracapacitor-based energy storage module 106. It will be appreciated by one skilled in the art that ultracapacitor-based energy storage module 106 may be connected directly to a DC link 108, essentially operating as a low-pass filter. An inverter 110 may be arranged to receive power from DC link to energize electrical drive system 52 (FIG. 1) to drive one or more hydraulic pumps 54 (FIG. 1).

A control strategy that may be applied to this topology allows the DC-link voltage to vary within a range so that energy in ultracapacitor-based energy storage module 106 can be more effectively used in combination with energy from battery-based energy storage module 104. For readers desirous of further background information regarding various alternative circuit topologies that may be used based on the needs of a given application, see paper titled “A New Battery/Ultracapacitor Hybrid Energy Storage System for Electric, Hybrid, and Plug-In Hybrid Electric Vehicles by J. Caoa and A. Emadi, published in IEEE Transactions on Power Electronics, Vol. 27, No. 1 Jan. 2012.

To implement the foregoing features, in one non-limiting embodiment EMS 20 (FIG. 1) may be configured to execute a power control strategy for blending power from HESS 100 and power generated by electromotive machine (12) to meet variable power demands of hydraulic fracturing subsystem 50 subject to optimized utilization of ultracapacitor-based energy storage module 106 and battery-based energy storage module 104.

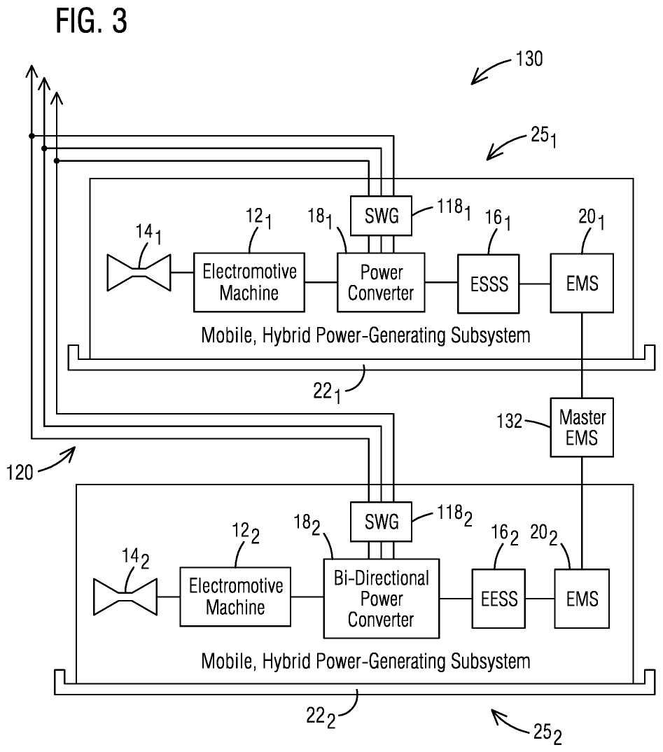

FIG. 3 illustrates a block diagram where two or more disclosed mobile, hybrid power-generating subsystems, as described in the context of FIG. 1, such as mobile hybrid power-generating subsystems 25₁ and 25₂, may be used as individual building blocks that may be electrically-connectable through respective switching gears 118₁, 118₂ to a power bus 120 to form a scalable, mobile micro-grid hybrid power-generating system 130 that may be used to power one or more hydraulic fracturing subsystem/s 50 (FIG. 1). A master EMS 132 may be configured to implement a coordinated load-sharing strategy for mobile hybrid power-generating subsystems 25₁ and 25₂, such as based on dynamically-changing power needs of the one or more hydraulic fracturing subsystem/s 50 being powered by scalable, mobile micro-grid hybrid power-generating system 130.

In one non-limiting embodiment, EMS 20 may be configured to autonomously select electrical energy storage system 16 as a supplemental power source to stabilize voltage and/or frequency deviations that may arise in hybrid power-generating system 130 during transient loads in mobile hydraulic fracturing subsystem 50.

In operation, disclosed embodiments avoid a need of system configurations involving multiple levels of prime mover redundancies and enable a relatively more compact mobile power-generating system easier to transport from site-to-site and easier to move or position in well sites, where paved roads and space to maneuver may not be readily available.

Without limitation, disclosed embodiments are believed to cost-effectively and reliably meet the necessary power-generation needs of hydraulic fracturing subsystem/s by way of optimized utilization of electrical energy derived from a gas turbine engine and electrical energy supplied by an electrical energy storage system. Disclosed embodiments may also offer a self-contained, mobile hybrid power-generating subsystem that may operate fully independent from utility power or external power sources including black-start capability for a gas turbine engine.

While embodiments of the present disclosure have been disclosed in exemplary forms, it will be apparent to those skilled in the art that many modifications, additions, and deletions can be made therein without departing from the scope of the invention and its equivalents, as set forth in the following claims.

1. A system for hydraulic fracturing, the system comprising:
a gas turbine engine;
an electrical energy storage system; and
an electromotive machine mechanically coupled to the gas turbine engine, the electromotive machine configured to operate in a motoring mode or in a generating mode, the electromotive machine in the motoring mode responsive to electrical power from the electrical energy storage system to provide a black start of the gas turbine engine,
wherein the gas turbine, the electrical energy storage system and the electromotive machine being arranged on a respective power generation mobile platform.

2. The system of claim 1, further comprising a hydraulic fracturing subsystem comprising at least one hydraulic pump powered by an electric drive system at least in part responsive to electrical power generated by the electromotive machine during the generating mode, the at least one hydraulic pump arranged to deliver a pressurized fracturing fluid.

3. The system of claim 2, wherein the least one hydraulic pump and the electric drive system of the hydraulic fracturing subsystem being arranged on a respective mobile platform.

4. The system of claim 1, wherein the electrical energy storage system comprises a battery energy storage system.

5. The system of claim 4, further comprising a bi-directional power converter electrically interconnected between the energy storage system and the electromotive machine to selectively provide bi-directional power conversion between the electrical energy storage system and the electromotive machine.

6. The system of claim 5, further comprising an energy management system configured to execute a power control strategy for blending power from the electrical energy storage system and power generated by the electromotive machine to meet variable power demands of the hydraulic fracturing subsystem.

7. The system of claim 6, wherein the energy management system is configured to control a state of charge of the battery energy storage system.

8. The system of claim 6, wherein the energy management system is configured to autonomously select the electrical energy storage system as a supplemental power source to meet peak loads in the mobile hydraulic fracturing subsystem.

9. The system of claim 6, wherein the bi-directional power converter, and the energy management system being arranged on the respective power generation mobile platform, and in combination with the gas turbine engine, the electrical energy storage system and the electromotive machine constitute a hybrid power generating subsystem that can be arranged to form a mobile micro-grid hybrid power system with at least a further one of the mobile hybrid power subsystem.

10. The system of claim 9, wherein the energy management system is configured to autonomously select the electrical energy storage system as a supplemental power source to stabilize voltage and/or frequency deviations that arise in the mobile micro-grid hybrid power system during transient loads in the hydraulic fracturing subsystem.

11. The system of claim 2, wherein the electrical energy storage system comprises a hybrid electrical energy storage system.

12. The system of claim 11, wherein the hybrid electrical energy storage system comprises an ultracapacitor-based energy storage module and a battery-based energy storage module.

13. The system of claim 12, further comprising an energy management system configured to execute a power control strategy for blending power from the hybrid electrical storage system and power generated by the electromotive machine to meet variable power demands of the hydraulic fracturing subsystem subject to optimized complementary utilization of the ultracapacitor-based energy storage module and the battery-based energy storage module.

14. A system for hydraulic fracturing, the system comprising:
a gas turbine engine;
an electrical energy storage system;
an electromotive machine mechanically coupled to the gas turbine engine, the electromotive machine configured to operate in a motoring mode or in a generating mode, the electromotive machine in the motoring mode responsive to electrical power from the electrical energy storage system to provide a black start of the gas turbine engine;
a bi-directional power converter electrically interconnected between the energy storage system and the electromotive machine to selectively provide bi-directional power conversion between the electrical energy storage system and the electromotive machine; and
an energy management system configured to execute a power control strategy for blending power from the energy storage system and power generated by the electromotive machine during the generating mode to meet variable power demands of a hydraulic fracturing subsystem,
wherein the gas turbine engine, the electrical energy storage system, the electromotive machine, the bi-directional power converter, and the energy management system being arranged on a respective power generation mobile platform.

15. The system of claim 14, wherein the gas turbine engine, the electrical energy storage system, the electromotive machine, the bi-directional power converter, and the energy management system in combination constitute a building block of a mobile micro-grid hybrid power generating system independent from utility power.

16. The system of claim 14, wherein the hydraulic fracturing subsystem comprises at least one hydraulic pump powered by at least one electric drive system responsive to blended power based on the power control strategy by the energy management system, the at least one pump arranged to deliver a pressurized fracturing fluid.

17. The system of claim 16, wherein the hydraulic fracturing subsystem comprises a mobile hydraulic fracturing subsystem, wherein the least one hydraulic pump and the least one electric drive system being arranged on a respective mobile platform.

18. The system of claim 14, wherein the electrical energy storage system comprises a battery energy storage system.

19. The system of claim 18, wherein the energy management system is configured to control a state of charge of the battery energy storage system.

20. The system of claim 19, wherein the energy management system is configured to autonomously select the battery energy storage system as a supplemental power source to meet peak loads in the hydraulic fracturing subsystem.

21. The system of claim 19, further comprising an electrically-connectable power bus arranged to form a scalable, mobile micro-grid hybrid power system with at least a further one of the mobile hybrid power subsystem.

22. The system of claim 21, wherein the energy management system is configured to autonomously select the electrical energy storage system as a supplemental power source to stabilize voltage and/or frequency deviations that arise in the mobile micro-grid hybrid power system during transient loads in the hydraulic fracturing subsystem.

23. The system of claim 14, wherein the electrical energy storage system comprises a hybrid electrical energy storage system.

24. The system of claim 23, wherein the hybrid electrical energy storage system comprises an ultracapacitor-based energy storage module and a battery-based energy storage module.

25. The system of claim 24, further comprising an energy management system configured to execute a power control strategy for blending power from the hybrid electrical storage system and power generated by the electromotive machine to meet variable power demands of the hydraulic fracturing subsystem subject to optimized complementary utilization of the ultracapacitor-based energy storage module and the battery-based energy storage module.
